(19) United States
(12) Patent Application Publication
(10) Pub. No.: US 2020/0219242 A1
(43) Pub. Date: Jul. 9, 2020

(54) ELECTRONIC DEVICE AND METHOD FOR MONITORING A SCENE AROUND A MOTOR VEHICLE, RELATED MOTOR VEHICLE, TRANSPORT SYSTEM AND COMPUTER PROGRAM

(71) Applicant: TRANSDEV GROUP, Issy Les Moulineaux (FR)

(72) Inventors: Cem KARAOGUZ, Palaiseau (FR); Alexis BEAUVILLAIN, Massy (FR)

(21) Appl. No.: 16/733,672

(22) Filed: Jan. 3, 2020

(30) Foreign Application Priority Data
Jan. 4, 2019 (FR) 19 00064

(51) Int. Cl. G06T 5/50; G08G 1/16; B60R 11/04

(52) U.S. Cl. CPC G06T 5/50; G08G 1/16; G06T 2207/30261; G06T 2207/20221; B60R 11/04

(57) ABSTRACT

An electronic monitoring device for monitoring a scene around a motor vehicle can be installed on the motor vehicle or along a public road network. It is capable of being connected to a primary sensor and to at least one secondary sensor. The primary sensor is an image sensor and each secondary sensor is distinct and separate from the primary sensor. The device includes a first acquisition module for acquiring at least one image of the scene from the primary sensor, and a second acquisition module for acquiring a set of one or more measurement point(s) relating to the scene from the at least one secondary sensor. A computation module computes an enriched image of the scene by superimposing a representation of an additional information item dependent on the set of one or more point(s) on to the acquired image. A transmission module transmits the enriched image to remote equipment.

### CROSS-REFERENCE TO RELATED APPLICATIONS

This application is a U.S. non-provisional application claiming the benefit of French Application No. 19 00064, filed on Jan. 4, 2019, which is incorporated herein by reference in its entirety.

### FIELD

The present invention relates to an electronic monitoring device for monitoring a scene around a motor vehicle, the device being designed to be embedded on board the motor vehicle and to be connected to a primary sensor and to at least one secondary sensor, the primary sensor being an image sensor and each secondary sensor being distinct and separate from the primary sensor.

The invention also relates to a motor vehicle, in particular an autonomous vehicle, comprising an image sensor and such an electronic monitoring device.

The invention also relates to a transport system including a fleet of one or more motor vehicle(s) and an electronic monitoring equipment for remote monitoring of the fleet of motor vehicle(s), the fleet comprising at least one such vehicle and the remote electronic equipment is configured to receive at least one enriched image from this motor vehicle.

The invention also relates to a monitoring method for monitoring a scene around such a motor vehicle, the method being implemented by such an electronic monitoring device.

The invention also relates to a non-transitory computer-readable medium including a computer program comprising software instructions which, upon being executed by a computer, implement such a monitoring method.

### BACKGROUND

The invention relates to the field of safe driving of motor vehicles, and in particular the field of automatic driving of autonomous motor vehicles.

Indeed, in the field of safe driving of motor vehicles, and in particular in autonomous driving, one of the main issues of concern is the ability to ensure early identification of obstacles in the path of a vehicle in motion, thereby making it possible to apply corrective measures aimed at preventing the vehicle from striking these obstacles, as well as the transmission of information between each vehicle in the fleet and an electronic monitoring equipment for remote monitoring of the fleet of motor vehicle(s).

The obstacles considered are of any type, for example stationary or fixed obstacles, such as safety guardrails, and parked vehicles, or moving obstacles, for example other vehicles or pedestrians. It is understood that there is a critical need to avoid any collision between a vehicle in motion and such obstacles, and also to ensure proper transmission of information between each vehicle and the monitoring equipment.

Motor vehicles are already known, wherein each is equipped with a primary image sensor, a secondary sensor (for example a Light Detection And Ranging or LIDAR sensor) and an electronic monitoring device for monitoring a scene around the motor vehicle. The monitoring device comprises a first acquisition module configured to acquire at least one image of the scene from the primary sensor, a second acquisition module configured to acquire a set of one or more measurement point(s) relating to the scene from the secondary sensor, and a transmission module configured to transmit to a remote electronic equipment via a data link, the acquired image, on the one hand, and the set of one or more measurement point(s), on the other hand.

However, the transmission of these information items between the vehicle and the equipment is not always satisfactory, as the amount of data that can be transmitted via the data link is sometimes quite limited.

### SUMMARY

The goal of the invention is thus to remedy the drawbacks of the state of the art by providing a more efficient monitoring device, in particular in the case of limited data flowrate for the link between the monitoring device and the remote equipment.

To this end, the subject-matter of the invention relates to an electronic monitoring device for monitoring a scene around a motor vehicle, the device being designed to be embedded on board the motor vehicle or to be installed along the public road network, the device being capable of being connected to a primary sensor and to at least one secondary sensor, the primary sensor being an image sensor and each secondary sensor being distinct and separate from the primary sensor, the device comprising:
a first acquisition module configured to acquire at least one image of the scene, from the primary sensor;
a second acquisition module configured to acquire a set of one or more measurement point(s) relating to the scene, from the at least one secondary sensor;
a computation module configured to compute an enriched image of the scene, by superimposing on to the acquired image a representation of at least one additional information item depending from the set of one or more measurement point(s); and
a transmission module configured to transmit the enriched image to a remote electronic equipment via a data link.

Thus, with the monitoring device according to the invention, the set of one or more measurement point(s) is not transmitted separately over the data link towards the remote equipment, but is superimposed in the form of a corresponding representation to the acquired image, in order to obtain an enriched image. Only the enriched image, resulting from this superimposition of the representation and the acquired image, is then transmitted to the remote equipment.

In other words, the transmission module of the monitoring device according to the invention is then configured to transmit the enriched image to the remote electronic equipment via a data link, in the absence of a separate transmission of the acquired image, on the one hand, and the set of one or more acquired measurement point(s) on the other hand.

The amount of data to be transmitted via the data link and by the monitoring device according to the invention is therefore significantly less than with the monitoring device of the state of the art, which then makes it possible to improve the quality of the transmission of information items between the monitoring device and the remote equipment.

According to other advantageous aspects of the invention, the electronic monitoring device comprises one or more of the following features, taken into consideration in isolation or in accordance with any technically possible combination:
the additional information item is a projection of the set of one or more measurement point(s) in the plane of the acquired image;
the secondary sensor is a multilayer scanner sensor with scanning about an axis of rotation, that is configured to transmit the signals from a plurality of superimposed layers along its axis of rotation, and the representation of the projection of the set of one or more measurement point(s) is a set of one or more line(s), each line corresponding to the measurements effected by a layer;
the additional information item is a group of one or more obstacle(s) detected via the set of one or more measurement point(s);
the representation of the group of one or more obstacle(s) is a group of one or more border(s), each border corresponding to a delimitation of a detected obstacle;
the representation of the additional information item presents a variable appearance that varies as a function of the distance between an object associated with the additional information item represented and the secondary sensor that has acquired the set of one or more measurement point(s) corresponding to this additional information item;

the appearance preferably being a color and/or a form;
at least one secondary sensor is installed along the public road network and has a direction of measurement that is distinct from a viewing axis of the primary sensor, and the second acquisition module is configured to acquire, from the at least one secondary sensor installed along the public road network, the set of one or more point(s) along the direction of measurement that is distinct from the viewing axis of the primary sensor;
each secondary sensor is of a distinct type differing from the primary sensor type;

the type of sensor for each secondary sensor being preferably selected from the group consisting of: lidar (acronym for Light Detection and Ranging), leddar (acronym for Light-Emitting Diode Detection and Ranging), radar (acronym for Radio Detection and Ranging) and ultrasonic sensor;
the electronic monitoring device further comprises a switching module configured to switch between a first operation mode wherein the computation module is activated, the image sent by the transmission module then being the enriched image computed by the computation module, and a second operation mode wherein the computation module is deactivated, the image sent by the transmission module then being the image acquired by the first acquisition module;
the switching module is remotely controllable by the remote electronic equipment;
the additional information item is a free zone of a traffic lane;
the representation of the free zone, also referred to as the clear zone, is a border delimiting said free zone,

said border preferably having an appearance that is distinct from the appearance of each border of the group of one or more border(s) representing a respective group of one or more obstacle(s);
the additional information item also includes one or more supplementary indicators, such as a confidence index indicating level of confidence in detection of the one or more obstacle(s), a speed of a respective obstacle detected; and
each secondary sensor is embedded on board the motor vehicle or installed along the public road network.

The subject-matter of the invention also relates to a motor vehicle, in particular an autonomous vehicle, comprising an image sensor and an electronic monitoring device for monitoring a scene around the motor vehicle, the monitoring device being as defined here above.

The subject-matter of the invention also relates to a transport system including a fleet of one or more motor vehicle(s) and a remote electronic equipment, such as an electronic monitoring equipment for remote monitoring of the fleet of motor vehicle(s), with at least one motor vehicle being as defined here above, and the remote electronic equipment is configured to receive at least one enriched image from said at least one motor vehicle

The subject-matter of the invention also relates to a monitoring method for monitoring a scene around a motor vehicle, the method being implemented by an electronic monitoring device designed to be embedded on board the motor vehicle or to be installed along the public road network, the monitoring device being able to be connected to a primary sensor and to at least one secondary sensor, with the primary sensor being an image sensor and each secondary sensor being distinct and separate from the primary sensor, the method comprising the following steps:
acquiring at least one image of the scene, from the primary sensor;
acquiring a set of one or more measurement point(s) relating to the scene, from the at least one secondary sensor;
computing an enriched image of the scene, by superimposing on to the acquired image a representation of at least one additional information item depending from the set of one or more measurement point(s); and
transmitting the enriched image to a remote electronic equipment via a data link.

The subject-matter of the invention also relates to a non-transitory computer-readable medium including a computer program comprising software instructions which, upon being executed by a computer, implement a monitoring method as defined here above.

### BRIEF DESCRIPTION OF THE DRAWINGS

These features and advantages of the invention will become more clearly apparent upon reading the description which follows, given solely as a non-limiting example, and with reference made to the appended drawings, in which:

FIG. 1 is a schematic representation of a transport system according to the invention including a fleet of one or more motor vehicle(s) and a remote electronic equipment, such as an electronic monitoring equipment for remote monitoring of the fleet of one or more motor vehicle(s); at least one motor vehicle comprising an image sensor, and an electronic monitoring device for monitoring a scene around the vehicle, said vehicle preferably being an autonomous motor vehicle, and the remote electronic equipment being configured to receive at least one enriched image from said at least one motor vehicle;

FIGS. 2 to 5 are examples of an enriched image computed by a computation module included in the monitoring device, then transmitted to the remote electronic equipment by a transmission module of the monitoring device; and

FIG. 6 is a flowchart of a monitoring method according to the invention, for monitoring a scene around the motor vehicle.

### DETAILED DESCRIPTION

In the following of the description, the expression “substantially equal to” refers to an equality relationship of plus or minus 10%, preferably plus or minus 5%. The expression “substantially perpendicular” refers to a relationship with an angle of 90° plus or minus 10°, preferably plus or minus 5°. The expression “substantially parallel” refers to a relationship with an angle of 0° plus or minus 10°, preferably plus or minus 5°.

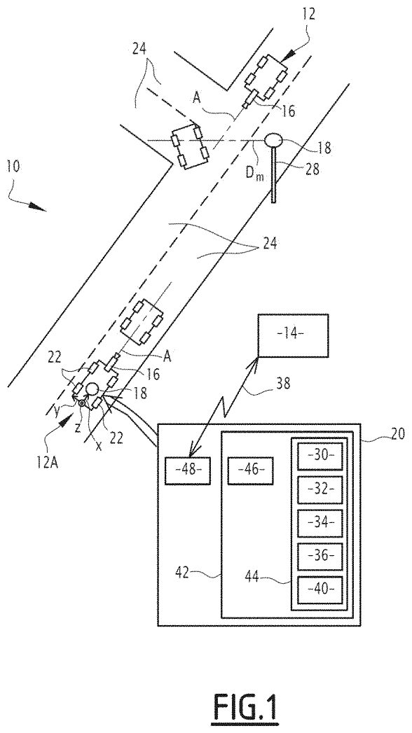

In FIG. 1, a transport system 10 comprises a fleet of one or more motor vehicle(s) 12 and a remote electronic equipment 14. Among the fleet of one or more motor vehicle(s) 12, at least one motor vehicle 12 is an autonomous motor vehicle and is then denoted as 12A. The fleet preferably comprises a plurality of motor vehicles 12, each motor vehicle preferably being an autonomous motor vehicle 12A.

In the example of FIG. 1, at least one motor vehicle 12, in particular an autonomous motor vehicle 12A, comprises a primary sensor 16, at least one secondary sensor 18, and an electronic monitoring device 20 for monitoring a scene around said vehicle. The monitoring device 20 is designed to be embedded on board the motor vehicle 12 and to be connected to the primary sensor 16 and to at least one secondary sensor 18.

As a variant, not shown, the primary sensor 16, the at least one secondary sensor 18 and the electronic monitoring device 20 are each installed over the public road network, along the traffic lanes 24. According to this variant, the primary sensor 16, the at least one secondary sensor 18, and the monitoring device 20 are all arranged in a single geographic position, for example within the interior of a single protective casing, not shown. Alternatively, the primary sensor 16, the at least one secondary sensor 18 and the monitoring device 20 are arranged in distinct geographic positions, while also being relatively close, typically separated by at the very most 200 m.

In the following section/s of the description, the terms “front”, “rear”, “right”, “left”, “top”, “bottom”, “longitudinal”, “transverse” and “vertical” are to be understood with reference to the usual orthogonal axis system, associated with the motor vehicle 12, as shown in FIG. 1 and having:
a longitudinal axis X directed from the rear towards the front;
a transverse axis Y directed from right to left; and
a vertical axis Z directed from bottom to top.

The person skilled in the art will then understand that each motor vehicle 12, 12A is represented in a view from the top on the schematic view of FIG. 1, the black rectangles symbolizing the wheels 22 of each motor vehicle 12.

When the motor vehicle is an autonomous motor vehicle 12A, it preferably has a level of automation that is greater than or equal to 3 according to the rating scale of the International Organization of Motor Vehicle Manufacturers (officially, Organisation Internationale des Constructeurs d'Automobiles, OICA). The level of automation is then equal to 3, that is to say Conditional Automation (as per the accepted terminology), or equal to 4, that is to say High Automation (as per the accepted terminology), or indeed equal to 5, that is to say Full Automation (as per the accepted terminology).

According to the OICA scale, the level 3 of conditional automation corresponds to a level for which the driver, while not needing to constantly monitor the dynamic driving or the driving environment, needs to continue having the ability to regain control of the autonomous motor vehicle 12A. According to this level 3, an autonomous driving management system, installed on board the autonomous motor vehicle 12A, then executes the longitudinal and lateral driving in a defined use case and is capable of recognizing its performance limits in order to then ask the driver to resume the dynamic driving while providing for sufficient time allowance.

The level 4 of high automation corresponds to a level for which the driver is not required in a defined use case. According to this level 4, the autonomous driving management system, installed on board the autonomous motor vehicle 12A, then executes the dynamic lateral and longitudinal driving in all the situations of this defined use case. The level 5 of complete automation finally corresponds to a level for which the autonomous driving management system, installed on board the autonomous motor vehicle 12A, executes the dynamic lateral and longitudinal driving in all the situations encountered by the autonomous motor vehicle 12A, throughout its entire trip. Thus no driver is then required.

Each motor vehicle 12, 12A is capable of travelling over one or more traffic lanes 24, as is visible in FIG. 1.

The remote electronic equipment 14 is, for example, an electronic monitoring equipment that is capable of remotely monitoring, or indeed even remotely controlling, the fleet of one or more motor vehicle(s) 12, the monitoring equipment also being referred to as PCC (acronym for Poste de Commande Central/Central Control Station). The remote electronic equipment 14 is configured to receive at least one enriched image 26 from said at least one motor vehicle 12 including a respective monitoring device 20.

Each primary sensor 16 is an image sensor that is capable of taking at least one image of a scene around the motor vehicle 12 within which it is embedded. Each primary sensor 16 is intended to be connected to the electronic monitoring device 20. Each primary sensor 16 comprises for example a matrix photodetector, which is capable of taking successive images.

Each primary sensor 16 has a viewing axis A. The viewing axis A is typically substantially perpendicular to the matrix photodetector.

Each primary sensor 16 is preferably directed towards the front in relation to the motor vehicle 12 within which it is embedded, as shown in FIG. 1. As a variant, the primary sensor 16 is oriented towards the rear in relation to the motor vehicle 12. When the primary sensor 16 is directed towards the front or towards the rear, its line of sight is typically substantially parallel to the longitudinal axis X. As another variant, the primary sensor 16 is oriented along the transverse axis Y, towards the left or indeed towards the right of the motor vehicle 12.

Each secondary sensor 18 is intended to be connected to the electronic monitoring device 20. The person skilled in the art will observe that each secondary sensor 18 is nevertheless not necessarily intended to be embedded on board within the motor vehicle 12 which includes the primary sensor 16.

In the example of FIG. 1, one secondary sensor 18 is embedded on board within the autonomous motor vehicle 12A which comprises the electronic monitoring device 20, and another secondary sensor 18 is installed over the public road network, along the traffic lanes 24.

Each secondary sensor 18 installed along the public road network is for example fixed to a vertical mast 28, as in the example of FIG. 1, or to a building. Each secondary sensor 18 installed along the public road network preferably has a direction of measurement Dm that is distinct from the viewing axis A of the primary sensor 16.

Each secondary sensor 18 is distinct and separate from the corresponding primary sensor 16. In particular, each secondary sensor 18 is of a distinct type differing from the corresponding primary sensor 16 type. As for the type of primary sensor 16, as previously indicated above, it is an image sensor, that is to say photo sensor or camera. The type of sensor for each secondary sensor 18 being preferably selected from the group consisting of: lidar (acronym for Light Detection and Ranging), leddar (acronym for Light-Emitting Diode Detection and Ranging), radar (acronym for Radio Detection and Ranging) and ultrasonic sensor.

The person skilled in the art will then understand that each secondary sensor 18 is preferably configured to carry out a measurement of its environment in order to obtain a set of one or more measurement point(s), also referred to as cloud of measurement point(s), by emission of a plurality of measurement signals in different directions of emission, then followed by reception of signals resulting from the reflection, by the environment, of the measurement signals emitted, the measurement signals emitted being typically light signals, radio signals, or even ultrasonic signals. The person skilled in the art will additionally also understand that, in this case, the direction of measurement Dm of the secondary sensor 18 corresponds to a mean direction, or indeed even a median direction, of the plurality of directions of transmission of the measurement signals.

In optional addition, the secondary sensor 18 is additionally also a multilayer scanner sensor with scanning about an axis of rotation that is configured to transmit the measurement signals from a plurality of superimposed layers along its axis of rotation. The secondary sensor 18 is then said to be a scanning sensor because it is able to scan successive angular positions about the axis of rotation, and to receive, for each respective angular position, and in reception positions staggered along the axis of rotation, the signals reflected by the environment of the secondary sensor 18, the reflected signals resulting, as previously indicated above, from a reflection of the environment of signals previously emitted by an emission source, such as a laser source, radio source or indeed even an ultrasonic source, included in the secondary sensor 18. For each angular position, the secondary sensor 18 then receives the signals reflected by an object from the environment of the secondary sensor 18, this being on multiple levels along the axis of rotation. The disposing of the beams of the secondary sensor in a plurality of layers makes it possible for the secondary sensor 18 to have a three-dimensional view of the environment, also referred to as a 3D view.

In the example of FIG. 1, the secondary sensor 18 embedded within the autonomous motor vehicle 12A is a multilayer and scanning sensor whose axis of rotation extends substantially along the vertical axis Z, such as a LIDAR sensor.

When, as a variant, the primary sensor 16, the at least one secondary sensor, 18 and the electronic monitoring device 20 are each installed along the public road network, they are for example all fixed to a single vertical mast 28, or indeed even to a single building, or alternatively fixed to separate and distinct vertical masts 28 and/or buildings.

The electronic monitoring device 20 is configured to monitor a scene around the motor vehicle 12 wherein it is embedded on board. The monitoring device 20 comprises a first acquisition module 30 that is configured to acquire at least one image of the scene, from the primary sensor 16, and a second acquisition module 32 that is configured to acquire a set of one or more measurement point(s) relating to the scene, from the one or more secondary sensor(s) 18 to which it is connected.

According to the invention, the monitoring device 20 further comprises a computation module 34 configured to compute a respective enriched image 26 of the scene, by superimposing, on to the image acquired by the first acquisition module 30, a representation R of at least one additional information item depending from the set of one or more measurement point(s).

The monitoring device 20 further comprises a transmission module 36 configured to transmit an image, such as the enriched image 26, to the remote electronic equipment 14 via a data link 38, such as a wireless link, for example a radio link.

In optional addition, the electronic monitoring device 20 further comprises a switching module 40 configured to switch between a first operation mode wherein the computation module 34 is activated, the image sent by the transmission module 36 then being the enriched image 26 computed by the computation module 34, and a second operation mode wherein the computation module 34 is deactivated, the image sent by the transmission module 36 then being the image acquired by the first acquisition module 30. The switching module 40 is preferably remotely controllable by the remote electronic equipment 14.

In the example of FIG. 1, the electronic monitoring device 20 comprises an information processing unit 42 for example, formed by a memory 44 and a processor 46 associated with the memory 44. The electronic monitoring device 20 comprises a transceiver 48 in particular configured to transmit, for example in the form of radio waves, the data, such as the image, transmitted by the transmission module 36 to the remote electronic equipment 14. The transceiver 48 is in addition configured to receive, in the reverse direction, the data from the remote electronic equipment 14, in particular for the controlling of the switching module 40 by the remote electronic equipment 14.

In the example of FIG. 1, the first acquisition module 30, the second acquisition module 32, the computation module 34, and the transmission module 36, as well as in optional addition the switching module 40, are each produced in the form of a software application, or a software block, that is executable by the processor 46. The memory 44 of the electronic monitoring device 20 is then able to store a first acquisition software application configured to acquire, from the primary sensor 16, at least one image of the scene, a second acquisition software application configured to acquire, from the at least one secondary sensor 18 to which the monitoring device 20 is connected, a set of one or more measurement point(s) relating to the scene, a computation software application configured to compute the enriched image 26 of the scene by superimposing on to the acquired image by the first acquisition software application, the representation R of at least one additional information item depending from the set of one or more measurement point(s) acquired by the second acquisition software application, and a transmission software application configured to transmit an image, in particular the enriched image 26, to the remote electronic equipment 14 via the data link 38. In optional addition, the memory 44 is also capable of storing a switching software application configured to switch between the first operation mode and the second operation mode. The processor 46 is then able to execute each of the software applications from among the first acquisition software application, the second acquisition software application, the computation software application, and the transmission software application, as well as in optional addition, the switching software application.

As a variant, not shown, the first acquisition module 30, the second acquisition module 32, the computation module 34, and the transmission module 36, as well as in optional addition the switching module 40, are each produced in the form of a programmable logic component, such as an FPGA (abbreviation for Field Programmable Gate Array), or in the form of a dedicated integrated circuit, such as an ASIC (abbreviation for Application Specific integrated Circuit).

When the electronic monitoring device 20 is realized in the form of one or more software application(s), that is to say in the form of a computer program, it is in addition capable of being recorded on a support medium, not represented, which is readable by a computer. The computer-readable medium is, for example, a medium that is capable of saving and storing electronic instructions and of being coupled to a bus of an IT system. As an example, the readable medium is an optical disc, a magneto-optical disc, a Read-Only Memory (ROM), a Random-Access Memory (RAM), any type of non-volatile memory [for example Electrically Programmable Read Only Memory (EPROM), Electrically Erasable Programmable Read-Only Memory (EEPROM), FLASH, Non-Volatile Random-Access Memory (NVRAM), a magnetic card or an optical card. A computer program comprising software instructions is then saved and stored on the readable medium.

In the example of FIG. 1, the first acquisition module 30, the second acquisition module 32, the computation module 34, and the transmission module 36 are integrated within the single information processing unit 42, that is to say within the same single electronic computer.

The first acquisition module 30 is known per se, and is configured to acquire, one by one or indeed in a grouped manner, successive images of the scene taken by the primary sensor 16.

The second acquisition module 32 is configured to acquire the set of one or more measurement point(s) relating to the scene, as observed by the corresponding secondary sensor 18, this acquisition being carried out for each angular position of the secondary sensor 18 when this secondary sensor is a scanner sensor, or else in a grouped manner upon conclusion of a complete rotational turn of the scanner sensor.

When the secondary sensor 18 is installed along the public road network, the second acquisition module 32 is configured to acquire, from this secondary sensor 18 installed along the public road network, the set of one or more point(s) along the direction of measurement Dm that is distinct from the viewing axis A of the primary sensor 16.

The computation module 34 is configured to determine the representation R of the at least one additional information item depending from the set of one or more measurement point(s), and then to superimpose said representation R on to the image previously acquired by the first acquisition module 30.

The additional information item is for example a projection of the set of measurement points in the plane of the acquired image. The computation module 34 is thus then capable of determining this projection of the cloud of points in the plane of the acquired image, for example by making use of the following equation:

P_{C}=K_{C}E_{C}^{L}P_{L} (1)

where P_{L} represents a vector, respectively a matrix, of coordinates of a point, respectively of a plurality of points, in a coordinate reference frame associated with the secondary sensor 18,

E_{C}^{L} represents a matrix of transformation from the coordinate reference frame associated with the secondary sensor 18 to a coordinate reference frame associated with the primary sensor 16,

K_{C} is a projection matrix associated with the primary sensor 16, this matrix taking into account the intrinsic properties of the primary sensor 16, such as its focal length, its principal point, and

P_{C} is a vector, respectively a matrix, of the coordinates of the point, respectively of a plurality of points, in the plane of the acquired image.

Each transformation matrix E_{C}^{L} is typically obtained based on an intrinsic and extrinsic calibration process, as described for example in the article “Fast Extrinsic Calibration of a Laser Rangefinder to a Camera” by R. UNNIKRISHNAN et al., published in 2005.

In addition, an auto-calibration algorithm is used at the time of the generating or updating of these matrices, for example according to the following equation:

P_{S2}=T_{S2}^{S1}P_{S1} (2)

where T_{S2}^{S1} represents a general matrix of transformation from a coordinate reference frame associated with a first sensor S1 to a coordinate reference frame associated with a second sensor S2, the matrix TN incorporating all of the intermediate transformations between the coordinate reference frame of the first sensor S1 and that of the second sensor S2. In the previous example, this matrix is then denoted as T_{C}^{L} and is equal to the product of the projection matrix K_{C} with that of the transformation matrix E_{C}^{L}.

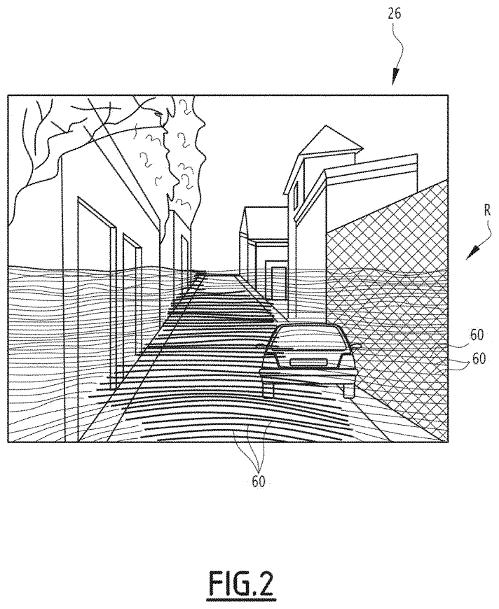

When the secondary sensor 18 is additionally also a multilayer scanning sensor, the representation R of the projection of the set of one or more measurement point(s) is a set of one or more line(s) 60, each line 60 corresponding to the measurements carried out by a layer, as shown in the example in FIG. 2.

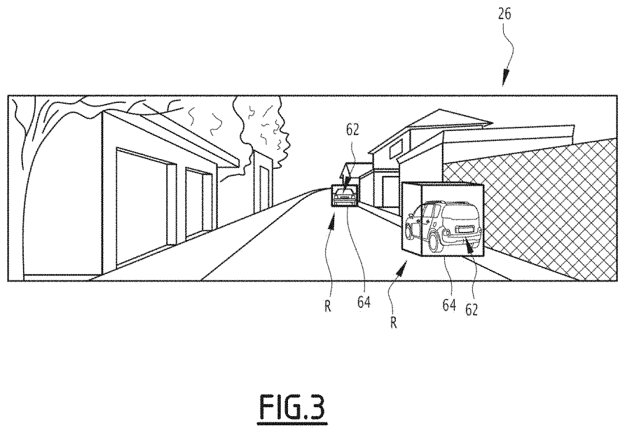

In addition or as a variant, the additional information item is a group of one or more obstacle(s) 62 detected via the set of one or more measurement point(s), and the representation R of the group of one or more obstacle(s) is then a group of one or more first border(s) 64, each first border 64 corresponding to a delimitation of an obstacle 62 detected, as represented in the example of FIG. 3.

The first border 64 of this representation R is for example a border in three dimensions, such as a polyhedron, typically a rectangular parallelepiped, as for the obstacle 62 in the foreground in FIG. 3. As a variant, the first border 64 of the representation R is a two-dimensional border, such as a polygon, typically a rectangle, as for obstacle 62 in the background in the example of FIG. 3.

The term “obstacle” is understood to refer to an object that is likely and able to impede or hinder the movement of the motor vehicle, said object being found on the corresponding traffic lane 24 or in the proximity thereof, or even moving in the direction of traffic lane 24.

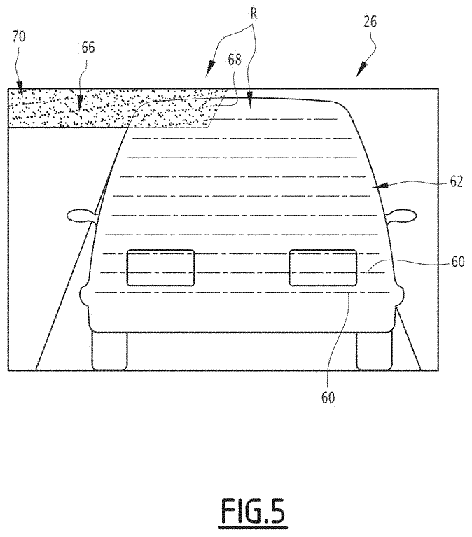

In addition or as a variant, the additional information item is a free zone 66 of a traffic lane 24, and the representation R of the free zone 66, also referred to as clear zone, is for example a second border 68 delimiting said free zone 66, as shown in the example of FIG. 5.

In a manner analogous to the first border 64 that delimits an obstacle 62, the second border 68 delimiting a respective free zone 66 is for example a border in three dimensions, such as a polyhedron, or even a border in two dimensions, such as a polygon.

The term “free zone” of a traffic lane is understood to refer to a clear zone of traffic lane 24, that is to say a zone, or portion, of the traffic lane 24 that is free of any obstacles and on which the motor vehicle 12 can thus then travel freely.

In order to facilitate the distinction between a free zone 66 and an obstacle 62, the second border 68 associated with the free zone 66 preferably has an appearance that is distinct from the appearance of each first border 64 of the group of one or more first border(s) representing a respective group of one or more obstacle(s) 62.

In optional addition, the additional information item moreover includes one or more supplementary indicators, such as a confidence index indicating level of confidence in detection of the one or more obstacle(s) 62, a speed of a respective obstacle 62 detected, or indeed even any other indicator relating to the corresponding obstacle 62 or to the corresponding free zone 66.

The computation module 34 is then configured to perform in particular the following operations:
detection of the ground;
detection, classification and/or location of one or more object(s), such as one or more obstacle(s) 62 and/or one or more free zone(s) 66;
calculation of speed and/or of the trajectory of the object, such as an obstacle 62 or a free zone 66;
filtering of points to be represented, for example representing only the points that do not correspond to the ground (non-horizontal orientation);
modification of the appearance, such as coloration, of the measurement points;
representation of bounding borders 64, 68 around the objects 62, 66; and
additional superimposition of metadata, such as speed of the object, class or type of the object, trajectory of the object, etc.

For the superimposition of the representation R on the image acquired by the first acquisition module, the computation module 34 in optional addition, is configured to modify a transparency index, or even an opacity index, of the representation R. This then makes it possible for the portion of the acquired image on which the representation R is superimposed to be rendered more or less visible. The person skilled in the art will in fact understand that the representation R superimposed on to the acquired image occupies only a part of said acquired image, or in other words its dimensions are smaller than those of the acquired image.

In optional addition, the representation R of the additional information item presents a variable appearance that varies as a function of the distance between an object, such as the obstacle 62 or the free zone 66, associated with the additional information item represented and the secondary sensor 18 that has acquired the set of one or more measurement point(s) corresponding to this additional information item. The appearance aspect that varies as a function of these distances is preferably a color and/or a form.

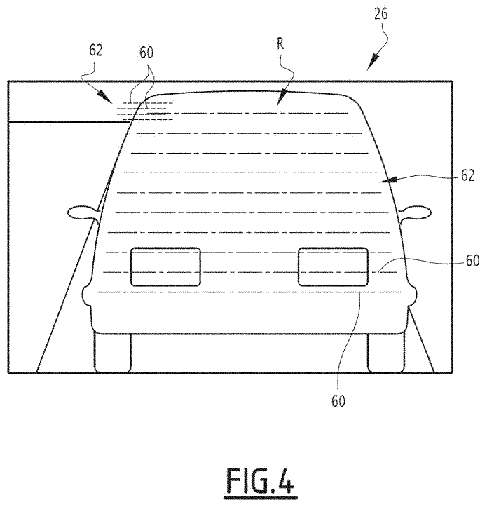

This optional addition with an appearance that is variable as a function of the distance is visible in the example of FIG. 4, where the representation R comprises, on the one hand, lines 60 represented in dashed lines, and on the other hand, other lines 60 represented in dotted lines. The dashed-lined lines 60 correspond to a first distance associated with a first obstacle 62, such as a motor vehicle, that happens to be in front of the motor vehicle 12 within which is embedded the monitoring device 20, and the dotted-lined lines 60 correspond to a second distance, which is greater than the first distance and associated with another obstacle 62 that happens to be further away and in front of the first obstacle 62.

A person skilled in the art will also observe that, in FIG. 4, the dotted-lined lines 60, associated with the other obstacle 62 that happens to be further away, correspond to a set of one or more point(s) acquired from a secondary sensor 18 installed along the public road network, and which is distinct from the secondary sensor 18 embedded on board the motor vehicle 12 that has enabled the acquiring of the set of one or more measurement point(s) corresponding to the dashed-lined lines 60, associated with the first obstacle 62.

This then makes it possible to determine/know that there is another obstacle 62 that happens to be positioned in front of the first obstacle 62 which precedes the motor vehicle 12 within which is embedded the monitoring device 20.

In further optional addition, or as a variant, the representation R of the additional information item presents a variable appearance that varies as a function of the orientation of the object, such as the obstacle 62 or the free zone 66, associated with the additional information item represented. The example in FIG. 2 illustrates this optional add-on of representations R with an appearance that is variable as a function of the orientation of the object associated with the additional information item represented, with the lines 60 illustrated in thick bold lines corresponding to the ground with an orientation that is substantially horizontal and the lines 60 illustrated in fine lines for the other objects not corresponding to the ground and having a substantially vertical orientation.

In further optional addition, or as a variant, the representation R of the additional information item presents a variable appearance that varies as a function of the height of the object, such as the obstacle 62 or the free zone 66, associated with the additional information item represented.

In the example of FIG. 4, the appearance aspect which varies is the form of the lines 60, this being on the one hand a dashed line and on the other hand a dotted line, and the person skilled in the art will obviously understand that the variable appearance aspect is alternatively a different color between these two sets of one or more line(s), or indeed even both a different form and a different color.

The example of FIG. 5 illustrates another example of representations R with a variable appearance that varies as a function of the distance between the object associated with the additional information item represented, such as a respective obstacle 62 or a respective free zone 66, and the secondary sensor 18 that has acquired the set of one or more measurement point(s) corresponding to this additional information item. In FIG. 5, the dashed-lined lines 60 are associated with the first obstacle 62, and correspond to the aforementioned first distance, while a zone of points 70 is associated with the free zone 66 that is delimited by the second border 68, this free zone 66 then corresponding to a second distance, between the free zone 66 and the corresponding secondary sensor 18, which is greater than the first distance.

The person skilled in the art will further also observe that, in FIG. 5, the points zone 70 associated with the free zone 66 corresponds, as with the dotted-lined lines 60 in FIG. 4, to a set of one or more point(s) acquired from a secondary sensor 18 that is installed along the public road network, and is distinct from the secondary sensor 18 embedded on board the motor vehicle 12 that provided the ability to acquire the set of one or more measurement point(s) corresponding to the dashed-lined lines 60, associated with the obstacle 62 which precedes the motor vehicle 12 within which is embedded the monitoring device 20.

The person skilled in the art will further understand that in the examples of FIGS. 4 and 5, the secondary sensor 18 embedded on board the motor vehicle 12 is a multilayer and scanning sensor, such that the representation R comprises the aforementioned lines 60, these lines 60 representing the projection of the set of measurement points reflected by the obstacle 62 that happens to be positioned in front of the motor vehicle 12. In these examples of FIGS. 4 and 5, the representation R associated with the obstacle 62 is therefore in the form of field lines, and does not have a first border 64.

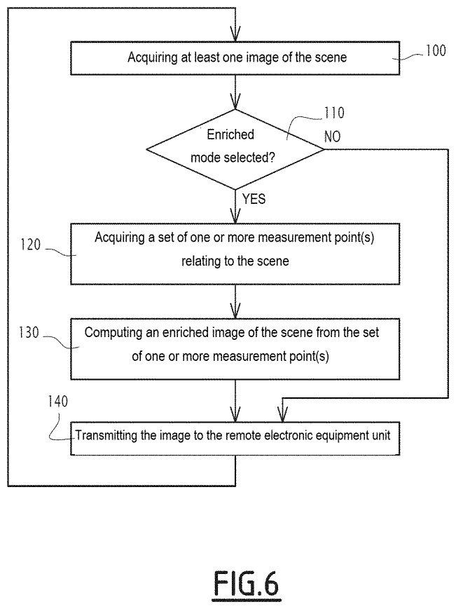

The operation of the electronic monitoring device 20 according to the invention will now be explained in view of FIG. 6 which represents a flowchart of the method, according to the invention, for monitoring the scene around the motor vehicle 12 within which is embedded the monitoring device 20, the method being implemented by said monitoring device 20.

During an initial step 100, the electronic monitoring device 20 acquires, via its first acquisition module 30 and from the primary sensor 16, at least one image of the scene, this image having been previously taken by the primary sensor 16.

The monitoring device 20 then determines during a test step 110, whether the first operation mode, also referred to as enriched mode, has been selected, or on the contrary whether the switching module 40 has switched to the second operation mode corresponding to a normal mode, without computation of enriched image.

If the first operation mode (enriched mode) has been selected, the monitoring method then goes to the step 120 during which the monitoring device acquires, via its second acquisition module 32 and from the one or more corresponding secondary sensor(s) 18, a set of one or more measurement point(s) relating to the scene, which has been previously observed, that is to say measured, by the one or more corresponding secondary sensor(s) 18.

As a variant, not shown, the acquisition steps 100 and 120 are carried out in parallel with one another, in order to facilitate a temporal synchronization of the image with the set of one or more measurement point(s) corresponding to this image.

According to this variant, the acquisition step 120 is for example carried out before the test step 110, and in the case of a negative outcome in the test of the step 110, that is to say if the second operation mode has been selected, then the set of one or more measurement point(s) acquired during the step 120 is not taken into account, and is for example deleted.

As another variant, not shown, the test step 110 is carried out in a preliminary manner. In the case of a positive outcome in the test of the step 110, that is to say if the first operation mode (enriched mode) has been selected, then the acquisition steps 100 and 120 are subsequently carried out in parallel relative to each other, in order to facilitate a temporal synchronization of the image with the set of one or more measurement point(s) corresponding to this image. Otherwise, in the case of a negative outcome in the test of the step 110, that is to say if the second operation mode has been selected, then only the acquisition step 100 is subsequently carried out in order to acquire the image, with the acquisition step 120 thus not being carried out. The set of one or more measurement point(s) is indeed not necessary in this second operation mode.

Following this acquisition step 120, during the step 130, the monitoring device 20 computes, via its computation module 34, the enriched image 26 of the scene from the set of one or more measurement point(s). More precisely, the computation module 34 then determines the representation R of the at least one additional information item depending from the set of one or more measurement point(s), as previously described above. It then superimposes the representation R thus determined, on to the image which was previously acquired during the initial step 100 by the first acquisition module 30.

The monitoring device 20 finally transmits, during the subsequent step 140 and via its transmission module 36, the enriched image 26 to the remote electronic equipment 14 via the data link 38, the remote equipment 14 being for example the electronic monitoring equipment that makes it possible to remotely monitor the fleet of one or more motor vehicle(s) 12, and the enriched image 26 then provides the ability to facilitate the monitoring of the scene around each motor vehicle 12 equipped with such a monitoring device 20.

At the end of the transmission step 140, the monitoring device 20 returns to the initial step 100 in order to acquire a new image of the scene via its first acquisition module 30.

At the end of the test step 110, if the result is negative, that is to say, if the operation mode is the second operation mode wherein the computation module 34 is deactivated, the monitoring device 20 goes directly from the test step 110 to the step of transmission 140, and the image transmitted by the transmission module 36 is then the image acquired by the first acquisition module 30, since the computation module 34 is then not activated to compute the enriched image 26.

At the end of this transmission step 140, the monitoring device 20 also returns to the initial step of acquisition 100 in order to acquire a subsequent image of the scene.

Thus, the monitoring device 20 according to the invention makes it possible not to transmit separately over the data link 38 between the monitoring device 20 and the remote equipment 14 the set of one or more acquired measurement point(s) of an acquired image of the scene, given that the computation module 34 provides the ability to superimpose on to the acquired image the representation R of the at least one additional information item as a function of this set of one or more measurement point(s), in order to obtain a respective enriched image 26. Only the enriched image 26, resulting from this superimposition of the representation R on to the acquired image, is then transmitted to the remote device 14, which thereby makes it possible to significantly reduce the amount of data passing through said data link 38, and then provides more efficient monitoring of the scene around the motor vehicle 12, in particular in the case of a limited data flowrate for the data link 38.

In optional addition, when the representation R includes one or more first border(s) 64 associated with the respective obstacles 62 and/or one or more second border(s) 68 associated with the free zones 66, the computation, followed by the transmission of the enriched image 26 according to the invention, makes it possible to further improve the monitoring of the scene around the motor vehicle 12, since this representation R moreover also provides an information item with respect to obstacles 62 and/or free zones 66 detected.

As a further optional addition, when the secondary sensor 18 is installed along the public road network and has its direction of measurement Dm that is distinct from the viewing axis A of the primary sensor 16, the monitoring device 20 according to the invention then makes it possible to detect other obstacles 62 that happen to be positioned in front of a first obstacle 62 which immediately precedes the motor vehicle 12, as illustrated in the example of FIG. 4, which provides the ability to further improve the monitoring of the scene around the motor vehicle 12. The person skilled in the art will in fact understand that the motor vehicle 12 equipped only with its on-board installed sensors would not otherwise have the ability to detect the one or more obstacle(s) that happen to be positioned in front of the first obstacle 62 which immediately precedes it.

It is thus understood that the monitoring device 20 according to the invention serves as the means to offer more efficient monitoring of the scene around the motor vehicle 12, in particular around the autonomous motor vehicle 12A.

What is claimed is:

1. An electronic monitoring device for monitoring a scene around a motor vehicle, the device being designed to be embedded on board the motor vehicle or to be installed along the public road network, the device being capable of being connected to a primary sensor and to at least one secondary sensor, the primary sensor being an image sensor and each secondary sensor being distinct and separate from the primary sensor, the device comprising:
a first acquisition module configured to acquire at least one image of the scene, from the primary sensor;
a second acquisition module configured to acquire a set of one or more measurement point(s) relating to the scene, from the at least one secondary sensor;
a computation module configured to compute an enriched image of the scene, by superimposing on to the acquired image a representation of at least one additional information item depending from the set of one or more measurement point(s); and
a transmission module configured to transmit the enriched image to a remote electronic equipment via a data link.

2. The device according to claim 1, wherein the additional information item is a projection of the set of one or more measurement point(s) in the plane of the acquired image.

3. The device according to claim 2, wherein the secondary sensor is a multilayer scanner sensor with scanning about an axis of rotation, configured to transmit the signals from a plurality of superimposed layers along its axis of rotation, and the representation of the projection of the set of one or more measurement point(s) is a set of one or more line(s), each line corresponding to measurements effected by a layer.

4. The device according to claim 1, wherein the additional information item is a group of one or more obstacle(s) detected via the set of one or more measurement point(s).

5. The device according to claim 4, wherein the representation of the group of one or more obstacle(s) is a group of one or more border(s), each border corresponding to a delimitation of a detected obstacle.

6. The device according to claim 1, wherein the representation of the additional information item presents a variable appearance that varies as a function of the distance between an object associated with the represented additional information item and the secondary sensor that has acquired the set of one or more measurement point(s) corresponding to this additional information item.

7. The device according to claim 1, wherein at least one secondary sensor is installed along the public road network and has a direction of measurement that is distinct from a viewing axis of the primary sensor, and the second acquisition module is configured to acquire, from the at least one secondary sensor installed along the public road network, the set of one or more point(s) along the direction of measurement that is distinct from the viewing axis of the primary sensor.

8. The device according to claim 1, wherein each secondary sensor is of a distinct type differing from the primary sensor type.

9. The device according to claim 8, wherein the type of sensor for each secondary sensor is selected from the group consisting of: lidar, leddar, radar and ultrasonic sensor.

10. A motor vehicle comprising an image sensor and an electronic monitoring device for monitoring a scene around the motor vehicle, wherein the monitoring device is according to claim 1.

11. A transport system including a fleet of motor vehicle(s) and a remote electronic equipment,
wherein at least one motor vehicle is according to claim 10, and the remote electronic equipment is configured to receive at least one enriched image from said at least one motor vehicle.

12. The transport system according to claim 11, wherein the remote electronic equipment is an electronic monitoring equipment for remote monitoring of the fleet of motor vehicle(s).

13. A monitoring method for monitoring a scene around a motor vehicle, the method being implemented by an electronic monitoring device designed to be embedded on board the motor vehicle or be installed along the public road network, the monitoring device being able to be connected to a primary sensor and to at least one secondary sensor, the primary sensor being an image sensor and each secondary sensor being distinct and separate from the primary sensor, the method comprising:
acquiring at least one image of the scene, from the primary sensor;
acquiring a set of one or more measurement point(s) relating to the scene from the at least one secondary sensor;
computing an enriched image of the scene, by superimposing on to the acquired image a representation of at least one additional information item depending from the set of one or more measurement point(s); and
transmitting the enriched image to a remote electronic equipment via a data link.

14. A non-transitory computer-readable medium including a computer program comprising software instructions which, upon being executed by a computer, implement a monitoring method according to claim 13.
